(19) United States
(12) Patent Application Publication
(10) Pub. No.: US 2026/0124511 A1
(43) Pub. Date: May 7, 2026

(54) PADDLE APPARATUS

(71) Applicant: Alliat, LLC, BATON ROUGE, LA (US)

(72) Inventor: Curtis Matthew Cruz, Baton Rouge, LA (US)

(21) Appl. No.: 19/376,939

(22) Filed: Nov. 1, 2025

Related U.S. Application Data
(60) Provisional application No. 63/714,999, filed on Nov. 1, 2024.

(51) Int. Cl. A63B 59/42; A63B 60/54; A63B 102/08; B32B 3/12; B32B 7/022

(52) U.S. Cl. CPC A63B 59/42; B32B 3/12; B32B 7/022; A63B 60/54; A63B 2102/08; A63B 2209/00; B32B 2250/03; B32B 2250/40; B32B 2307/546

(57) ABSTRACT

A paddle apparatus is provided herein comprising a first paddle face, a second paddle face, and a core positioned between the first paddle face and the second paddle face. Each of the first paddle face and the second paddle face may be substantially flat and one or more discontinuities may be defined in the core.

### CROSS-REFERENCE TO RELATED APPLICATIONS

The present application claims priority to, and benefit from, a U.S. provisional patent application filed on Nov. 1, 2024, identified as U.S. Appl. No. 63/714,999, and which is incorporated by reference in its entirety.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### FIELD OF THE DISCLOSURE

The present disclosure relates generally to paddle apparatus, and in particular, a pickleball paddle to be used in connection with the sport of pickleball and that otherwise is suitable for use in sanctioned and unsanctioned events.

### BACKGROUND

Originating in 1965, the sport of pickleball is a hybrid among tennis, table tennis, and badminton. According to an article published by Forbes, titled “What is Pickleball?” and authored by Kimberly Dawn Neumann (available at https://www.forbes.com/health/body/what-is-pickleball/), the sport (or game) of pickleball is one of the fastest growing sports in the United States and beyond. According to sources cited in the article, the sport of pickleball has experienced nearly a forty percent (40%) growth rate in the U.S. over the past two years, leading to widespread adoption of the game. But, as the sport of pickleball has become a fixture in the sporting industry, so too has it incurred criticism, particularly as with respect to the pickleball paddle used in gameplay.

Pickleball is played on a court that is 20 feet (6.10 meters) wide by 44 feet (13.41 meters) long. A net is affixed to the court, positioned perpendicular to a length of the court, for the purpose of dividing each competing player (or set of competing players). The equipment for pickleball is minimal: a pickleball paddle for each player and a pickleball ball. Unlike rackets in the games of tennis and badminton, a paddle is not stringed or wired—rather, it is merely flat. In addition to the paddle, the game of pickleball features a pickleball ball. The pickleball ball is similar to plastic baseballs, commonly referred to as whiffle balls. Whiffle balls are often comprised of plastic (or another elastomeric material) and are perforated with any number of holes.

In the years since the inception of pickleball, unique pickleball rules have been implemented, and standards have been adopted, for pickleball ball and paddle construction. Per the current national governing body of pickleball, USA Pickleball (formerly known as the USA Pickleball Association), equipment standards have been established, such that gameplay does not change significantly, unfairly, or prejudicially as a result of variance in the manufacture of pickleball balls and paddles. USA Pickleball prescribes specific structural limitations and specifications for the pickleball paddle. Each of these rules, identified under Section 2.E of USA Pickleball's Equipment Standards Manual (version 2.0 (November 2023)), are provided as follows.

Material. The paddle must be made of any material deemed safe and not prohibited by these rules. The paddle shall be made of rigid, non-compressible material meeting the criteria located on the USA Pickleball website.

Surface Roughness. The paddle's hitting surface shall not contain holes, indentations, rough texturing, or any objects or features that allow a player to impart excessive spin on the ball. Paddle roughness and friction characteristics are determined in two ways: (1) using a Starrett SR160 or SR300 Surface Roughness Tester (or equivalent). The allowable limits for roughness shall be an average of no greater than 30 micrometers (μm) on the Rz readings (average maximum height, peak to valley) and an average of no greater than 40 micrometers on the Rt readings (maximum height, peak to valley), with all readings to be taken in six different directions; and (2) a coefficient of friction test based on protocol (IAW) ASTM D1894-14 is used to measure the general friction characteristics regardless of surface finishing process or technology; a paddle will pass this test with a maximum kinetic coefficient of friction value of ≤0.1875.

Reflection. The paddle's hitting surface shall not be adversely reflective, such that it has the potential to negatively affect the vision of opposing player(s). Paddles shall not have any Measurement exceeding 80 GU. Measurement is to be taken at the universal measurement angle of 60 degrees with ETB-0833 Self-Calibration 20° 60° 85° Surface Gloss meter Tester 0-200 GU or equivalent.

Size. The combined length and width, including any edge guard and butt cap, shall not exceed 24 inches (60.96 cm). The paddle length cannot exceed 17 inches (43.18 cm). There is no restriction on paddle thickness.

Weight. There is no restriction on paddle weight.

Alterations. Altered paddles must meet all specifications. Player alterations or additions to a commercially produced paddle as certified, may include such items as edge guard tape/replacements, weighted tape, weights for an Original Equipment Manufacturer (OEM) integrated weight system, changes to the grip size via inserts, grip wraps, OEM interchangeable grips, OEM replacement paddle faces, and name decals and/or other identification markings on the paddle face. Decals and tape can extend no farther than 1.0 inch (2.54 cm) above the top of the grip nor more than 0.5 inch (1.27 cm) inside the outer edge of a paddle or, if an edge guard is in place, 0.5 inch inside the edge guard. Handwritten markings are allowed on the paddle's playing surface as long as they do not impact the surface roughness and are in good taste. No aftermarket graphics are allowed on a commercially made paddle other than “handwritten” pen markings.

Prohibited Features. The following are prohibited features: (1) anti-skid paint or any paint textured with sand, rubber or vinyl compounds or any material that causes additional spin; (2) rubber and synthetic rubber; (3) sandpaper characteristics; (4) moving parts that can increase head momentum with a proven increase in force (vibration dampers are acceptable); (5) removable parts except for edge guard tape/replacements, weighted tape, weights for an Original Equipment Manufacturer (OEM) integrated weight system, changes to the grip size via inserts, grip wraps, OEM interchangeable grips, OEM replacement paddle faces; (6) springs or spring-like material, flexible membranes or any compressible material that creates a trampoline effect; and (7) electrical, electronic, or mechanical assistance of any sort.

Model Designation. The manufacturer must have a clearly marked brand and model name or model number on the paddle, and must also include the ‘USA Pickleball Approved’ seal or text treatment. Paddles with different core material, surface material, or other significant differences must have a unique name or number.

The Official Pickleball rulebook also clearly identifies compliance requirements for approved paddles. Manufacturers are subject to compliance testing to ensure that the paddles being produced and sold comply with all requirements.

Prior-art pickleball paddles are manufactured via two primary processes, known as the “sandwich” method and the “thermoforming” method. Simply put, the sandwich method consists of stamping or die-cutting paddle shapes from bulk sheets of material and adhering them together to form a paddle. A simple example of this method is to cut a paddle shape from two composite laminate sheets and a sheet of polymer honeycomb and then adhere a composite sheet to both sides of the polymer honeycomb. From there a paddle can be finished out with details such as an edge guard, handle body and grip. Similarly, large sheets of composite and polymer cores can be bonded together and then die-cut or stamped to shape. The thermoforming method of paddle construction consists of wrapping a paddle core with composite prepreg and placing the assembly into a heated press, which cures the composite in the shape of a paddle. From there a paddle can be finished out with details such as an edge guard, handle body and grip.

An exemplary prior-art pickleball paddle 10 is depicted in FIG. 1. The prior-art pickleball paddle 10 may include a core 20, a pair of paddle faces, wherein each paddle face of the pair of paddle faces is referred to herein as a paddle face 30, an edge guard 40, and a grip 50.

There are certain drawbacks associated with the various manufacturing methods discussed above. As with any manufacturing method, many variables exist that can have a direct effect on the final product, such as labor efficiency, raw material cost, production timing and production quality to name a few examples. Careful attention must be paid to these variables, and many others, to ensure the production of commercially viable products. Additionally, due to the current state of manufacturing, prior-art pickleball paddles often suffer from inconsistent performance characteristics, even amongst paddles produced by the same manufacturer and within the same model/line.

Prior-art pickleball paddles have few, if any, discernable performance characteristics. The number of distinct brands selling paddles is a large multiple of the number of worldwide manufacturers of paddles. The effect of such a dynamic in a fast-growing market is the commoditization of the pickleball paddle market. Aside from graphics, the prior-art pickleball paddle designs fall into tight groupings based on core thickness, material selection, and/or manufacturing method. The most significant difference between these prior-art pickleball paddles tends to be their shape, which is severely constrained based on USA Pickleball's Equipment Standards Manual. Further, many of the variations in paddles have no effect on the performance characteristics of the paddle. There is no correlation between the thickness of prior-art pickleball paddles and the weight thereof.

As provided above, prior-art pickleball paddles, from a performance perspective, are indistinguishable from one another. Certain aspects of pickleball paddle performance may refer to the force the paddle is able to generate when contacting a pickleball ball, how the paddle feels in the hands of its user, and the control the paddle exhibits when contacting a pickleball ball, among other performance characteristics. The similarities of pickleball paddle material and construction utilized across the industry, combined with stringent limitations imposed by USA Pickleball's Equipment Standards Manual, has created a consensus among those of skill in the art that performance of pickleball paddles cannot be improved.

In fact, the standards imposed by USA Pickleball's Equipment Standards Manual have resulted in stagnation in innovation across the pickleball paddle industry. Certain companies have sought to improve their pickleball paddle by updating one aspect of performance, but it has always resulted in unacceptably negative performance in other aspects of the pickleball paddle. Given the number of drawbacks associated with prior-art pickleball paddles, along with shortcomings in the manufacture and/or fabrication thereof, there is a need to provide a pickleball paddle that overcomes the foregoing limitations.

### BRIEF SUMMARY

The present disclosure addresses the problems identified above, amongst others. Implementations consistent with the present disclosure provide a pickleball paddle having a first paddle face, a second paddle face, and a core positioned between the first paddle face and the second paddle face.

A paddle apparatus is provided herein comprising a first paddle face, a second paddle face, and a core positioned between the first paddle face and the second paddle face. Each of the first paddle face and the second paddle face may be substantially flat and one or more discontinuities may be defined in the core.

In accordance with certain exemplary embodiments, each of the one or more discontinuities may include a material removing cut defined in the core.

In accordance with certain exemplary embodiments, the core may be divided into two or more sections being separated by the one or more discontinuities.

In accordance with certain exemplary embodiments, the two or more sections of the core may include a first section comprising a first material and a second section comprising a second material, the first material and second material being different.

In accordance with certain exemplary embodiments, a stiffness of the first material may be different from a stiffness of the second material.

In accordance with certain exemplary embodiments, the one or more discontinuities may be in the shape of a circle.

In accordance with certain exemplary embodiments, the one or more discontinuities may include two or more linear lines that are substantially parallel to one another.

In accordance with certain exemplary embodiments, the one or more discontinuities may be H-shaped.

In accordance with certain exemplary embodiments, the one or more discontinuities may be U-shaped.

In accordance with certain exemplary embodiments, the core may include a pair of contact surfaces and a thickness defined between the pair of contact surfaces. The one or more discontinuities may be defined such that the one or more discontinuities extend through the thickness of the core from a first contact surface of the pair of contact surfaces to a second contact surface of the pair of contact surfaces.

In accordance with certain exemplary embodiments, the core may include a pair of contact surfaces and a thickness defined between the pair of contact surfaces. The one or more discontinuities may be defined such that the one or more discontinuities extend through the thickness of the core parallel to the pair of contact surfaces.

In accordance with certain exemplary embodiments, the one or more discontinuities may extend throughout the entirety of the thickness of the core parallel to the pair of contact surfaces.

In accordance with certain exemplary embodiments, the one or more discontinuities may extend through less than the entirety of the thickness of the core parallel to the pair of contact surfaces.

In accordance with certain exemplary embodiments, the paddle apparatus may include a deflection material positioned between the first paddle face and the core, and between the second paddle face and the core.

In accordance with certain exemplary embodiments, a stiffness of the deflection material may be less than a stiffness of the core.

In accordance with certain exemplary embodiments, the paddle apparatus may include one or more weighted portions positioned between the first paddle face and the second paddle face.

In accordance with certain exemplary embodiments, a first weighted portion of the one or more weighted portions may be positioned between the first paddle face and the core, and a second weighted portion of the one or more weighted portions may be positioned between the second paddle face and the core.

In accordance with certain exemplary embodiments, the core may include a honeycomb structure and the one or more weighted portions may be disposed within apertures of the honeycomb structure of the core.

In accordance with certain exemplary embodiments, the core may include a honeycomb structure having a plurality of apertures defined therein.

Unless otherwise defined, all technical and scientific terms used herein have the same meaning as commonly understood by one of ordinary skill in the art to which this disclosure belongs. The present disclosure may be embodied in other specific forms without departing from the spirit or essential attributes thereof, and it is therefore desired that the embodiments of the disclosure be considered in all aspects as illustrative and not restrictive. Any headings utilized in the description are for convenience only and no legal or limiting effect. Numerous objects, features, and advantages of the embodiments set forth herein will be readily apparent to those skilled in the art upon reading of the following disclosure when taken in conjunction with the accompanying drawings.

### BRIEF DESCRIPTION OF THE DRAWINGS

Hereinafter, various exemplary embodiments of the disclosure are illustrated in more detail with reference to the drawings.

FIG. 1 is an exploded perspective view of a prior-art embodiment of a pickleball paddle.

FIG. 2 is a front perspective view of an embodiment of a pickleball paddle in accordance with the present disclosure.

FIG. 3 is an front elevation view of the embodiment of the pickleball paddle of FIG. 2.

FIG. 4 is an exploded perspective view of the embodiment of the pickleball paddle of FIG. 2.

FIG. 5 is a cross-sectional view of a grip of the embodiment of the pickleball paddle of FIG. 2.

FIG. 6 is a front perspective view of an embodiment of a pickleball paddle in accordance with the present disclosure.

FIG. 7 is an exploded perspective view of the embodiment of the pickleball paddle of FIG. 6.

FIG. 8 is a left-side elevation view of the embodiment of the pickleball paddle of FIG. 6.

FIG. 9 is a left-side elevation view of the embodiment of the pickleball paddle of FIG. 6 wherein a modal shape is shown for an exemplary vibration.

FIG. 10A is a front elevation view of an exemplary embodiment of a core of a pickleball paddle, in accordance with the present disclosure, wherein the core includes a discontinuity.

FIG. 10B is a front elevation view of an exemplary embodiment of a core of a pickleball paddle, in accordance with the present disclosure, wherein the core includes a discontinuity.

FIG. 10C is a front elevation view of an exemplary embodiment of a core of a pickleball paddle, in accordance with the present disclosure, wherein the core includes a discontinuity.

FIG. 10D is a front elevation view of an exemplary embodiment of a core of a pickleball paddle, in accordance with the present disclosure, wherein the core includes a discontinuity.

FIG. 11 is a front perspective view of an exemplary embodiment of a core of a pickleball paddle, in accordance with the present disclosure, wherein the core includes discontinuities.

FIG. 12 is a front perspective view of an exemplary embodiment of a core of a pickleball paddle, in accordance with the present disclosure, wherein the core includes discontinuities.

FIG. 13 is a cross-sectional schematic view of an embodiment of a pickleball paddle, in accordance with the present disclosure, wherein a plurality of material layers are shown.

FIG. 14 is a cross-sectional schematic view of an embodiment of a pickleball paddle, in accordance with the present disclosure, wherein a plurality of material layers are shown.

FIG. 15 is an exploded perspective view of an embodiment of a pickleball paddle, in accordance with the present disclosure, wherein a plurality of weighted portions are associated with a core.

FIG. 16 is a front elevation view of the core of the embodiment of the pickleball paddle of FIG. 15 wherein the plurality of weighted portions are associated with the core.

FIG. 17 is an exploded perspective view of an embodiment of a pickleball paddle, in accordance with the present disclosure, wherein a plurality of weighted portions are associated with a core.

FIG. 18 is a front elevation view of the core of the embodiment of the pickleball paddle of FIG. 17 wherein the plurality of weighted portions are associated with the core.

### DETAILED DESCRIPTION

Reference will now be made in detail to embodiments of the present disclosure, one or more drawings of which are set forth herein. Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

While the making and using of various embodiments of the present disclosure are discussed in detail below, it should be appreciated that the present disclosure provides many applicable inventive concepts that can be embodied in a wide variety of specific contexts. The specific embodiments discussed herein are merely illustrative of specific ways to make and use the invention and do not delimit the scope of the disclosure.

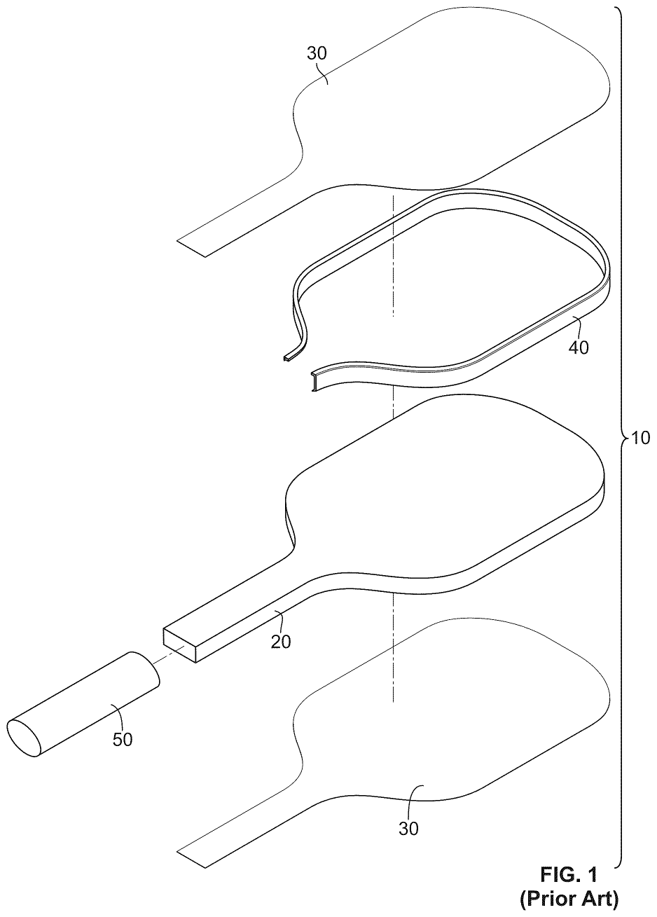

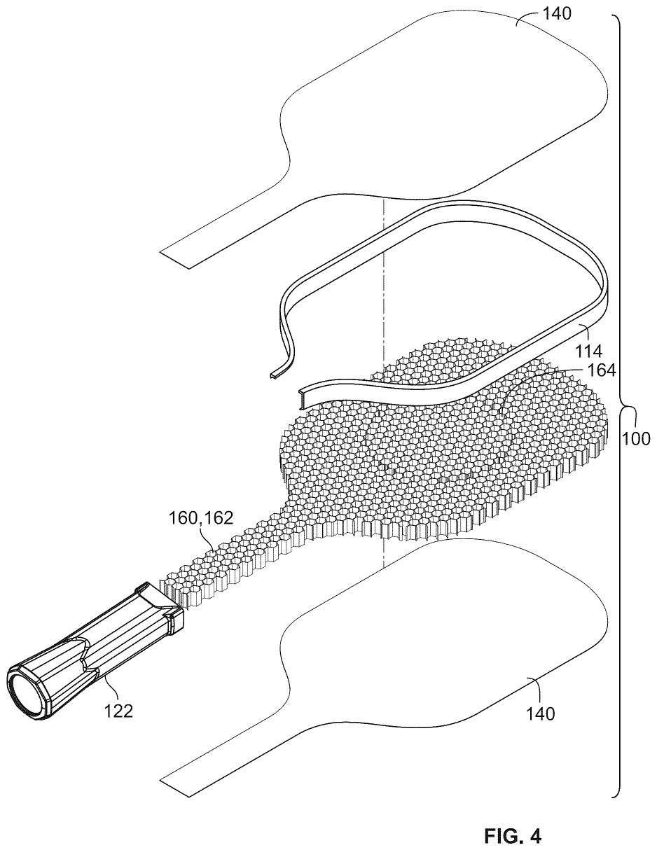

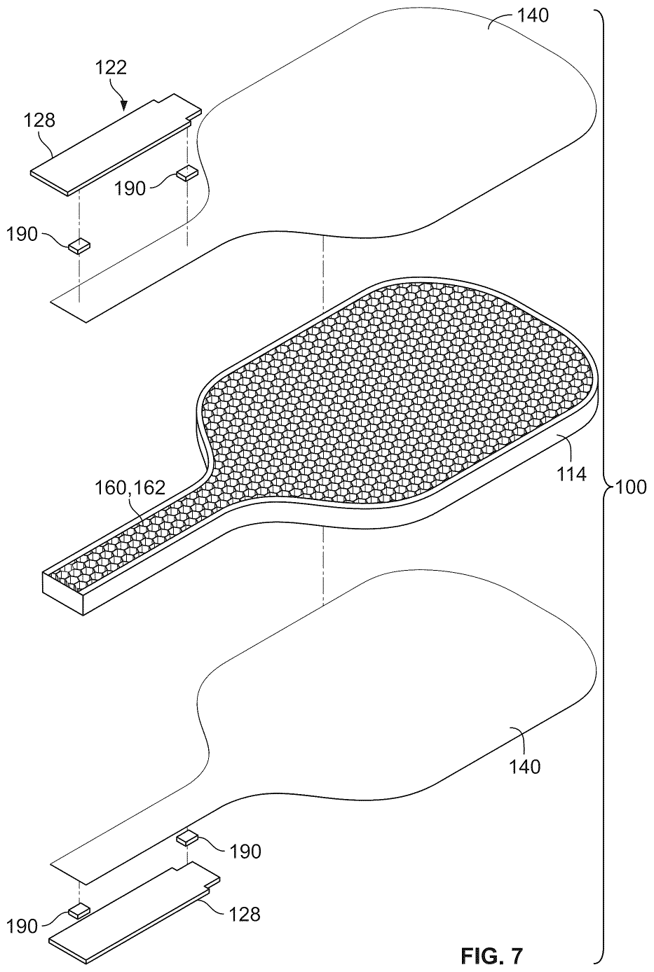

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure. Referring generally to FIGS. 1-18, various exemplary embodiments of a prior-art pickleball paddle 10, as described in the Background Section, and a pickleball paddle 100 of the present disclosure, may be described in detail.

Hereinafter, when referring to the prior-art pickleball paddle 10, or the pickleball paddle 100 of the present disclosure, such pickleball paddle may be referred to as either the “pickleball paddle,” the “paddle,” and/or the “pickleball apparatus.” The pickleball paddle 100 of the present disclosure may be formed of various materials, some of which may include carbon fiber composite, foam, and/or plastic to name a few examples.

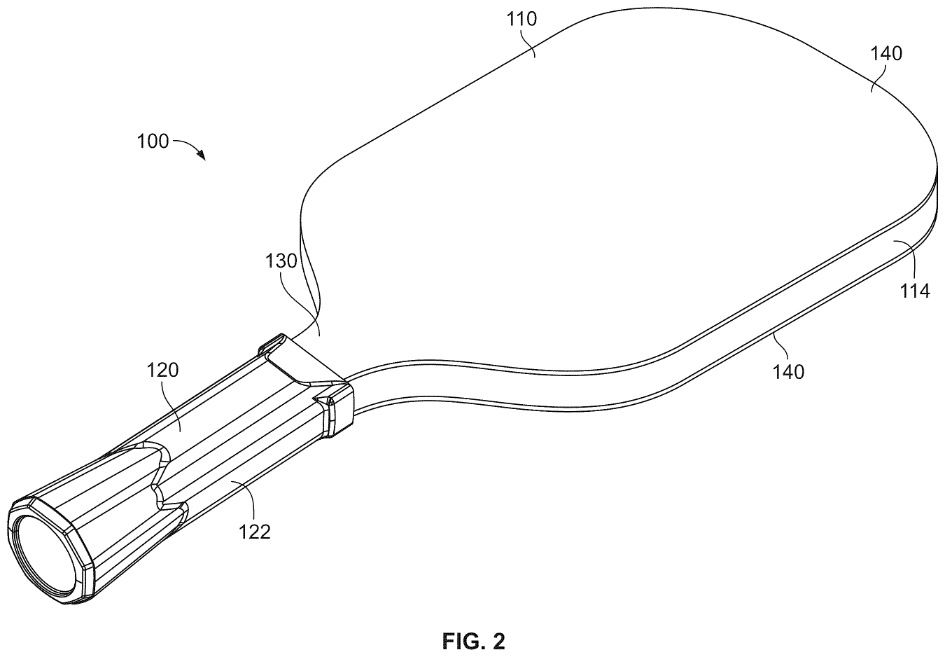

Referring now to FIGS. 2-15, provided are exemplary embodiments of a pickleball paddle 100 of the present disclosure. Referring now to FIGS. 2-4, the pickleball paddle 100 may include an impact portion 110, a grip portion 120, and a neck portion 130 connecting the impact portion 110 to the grip portion 120. The impact portion 110 may be configured for contacting an object, such as a pickleball ball. The grip portion 120 may be configured to be grasped by a user. While the term “impact” is used in association with the impact portion 110, one of skill in the art will understand that objects, such as pickleball balls, may be contacted with any portion of the pickleball paddle 100.

The pickleball paddle 100 may include a pair of paddle faces, wherein each paddle face of the pair of paddle faces is referred to herein as a paddle face 140. In certain optional embodiments, each paddle face 140 may be substantially flat and may extend across the impact portion 110, the grip portion 120, and/or the neck portion 130. In certain optional embodiments, each paddle face 140 may extend across only the impact portion 110 and the neck portion 130. In certain optional embodiments, the pair of paddle faces 140 may be constructed from a single material, such as a carbon fiber composite, whose stiffness may be at least partially controlled. However, the pair of paddle faces 140 may be constructed from any material and/or combination of materials known in the art.

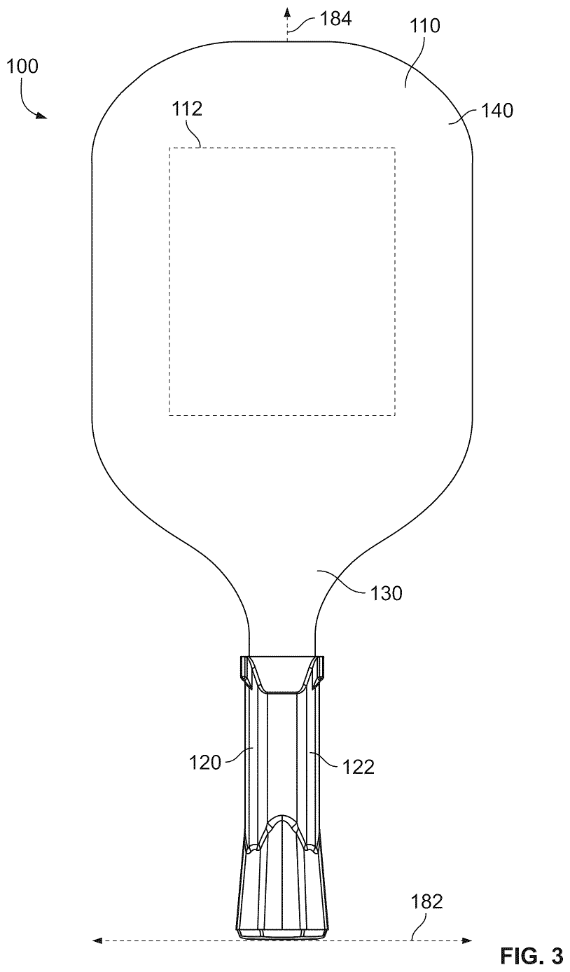

Each paddle face 140 may include a primary impact area 112. The primary impact area 112 may be located on or around the impact portion 110 and may be configured for contacting a pickleball ball. The primary impact area 112 may be positioned on or around a central area of each paddle face 140 inset from a periphery of the paddle face 140. In certain optional embodiments, it may be preferable for the user to contact a pickleball ball with the primary impact area 112 of the paddle face 140. An exemplary primary impact area 112 is depicted in FIG. 3.

In certain optional embodiments, the pickleball paddle 100 may include an edge guard 114. The edge guard 114 may be configured to reduce the amount of damage inflicted on an edge of the pickleball paddle 100, and specifically the edge of the impact portion 110, when the edge of the pickleball paddle 100 contacts the ground surface or other object/surface. The edge guard 114 may be configured to reduce abrasions, scratches, dents, and/or the like, for example, when a user inadvertently contacts the ground surface of a pickleball court.

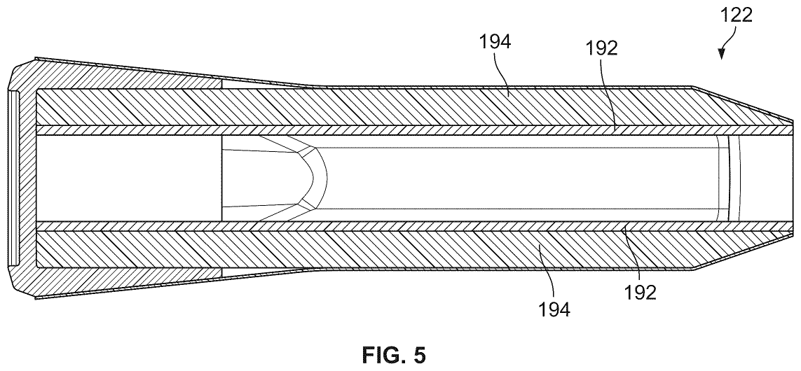

Referring now to FIGS. 5-8, in certain optional embodiments, the pickleball paddle 100 may include a grip 122. The grip 122 may be located at or near the grip portion 120. The grip 122 may be configured to be grasped by a user of the pickleball paddle 100 and may be further configured to provide frictional resistance such that rotation and/or translation of the pickleball paddle 100 relative to the user's hand is limited. The grip 122 may include grip tape that may be wrapped about the grip portion 120 of the pickleball paddle 100, or may otherwise surround the grip portion 120. In certain optional embodiments, the pickleball paddle 100 may further include a grip band. The grip band may be configured to maintain the position of the grip 122, and/or otherwise to assist in maintaining a user's hand position on the grip 122.

In certain exemplary embodiments, such as the embodiment shown in FIGS. 2-5, the grip 122 of the pickleball paddle 100 may include a plurality of dampening layers positioned adjacent to the grip portion 120 of each paddle face 140. FIG. 5 depicts a cross-sectional view of the terminal end of the pickleball paddle 100, and more specifically the grip portion 120. In certain optional embodiments, the plurality of dampening layers of the grip 122 may include a first dampening layer 192 and a second dampening layer 194. The first dampening layer 192 may be directly adjacent to and/or coupled to the grip portion 120 of each paddle face 140. The second dampening layer 194 may be directly adjacent to and/or coupled to the first dampening layer 192 such that the second dampening layer 194 is disposed between the first dampening layer 192 and an outer portion of the grip 122. Each of the first and second dampening layers 192, 194 may comprise a material configured to at least partially absorb and/or reduce vibrations, such as a foam to name one example. In certain optional embodiments the first dampening layer 192 may comprise a different material than the second dampening layer 194. In other optional embodiments, the first dampening layer 192 may comprise a similar material to the second dampening layer 194. While two (2) dampening layers are shown in the exemplary embodiment of the grip portion 120 shown in FIG. 5, it is within the scope of the present disclosure for the grip portion 120 to include a single dampening layer and/or more than two (2) dampening layers.

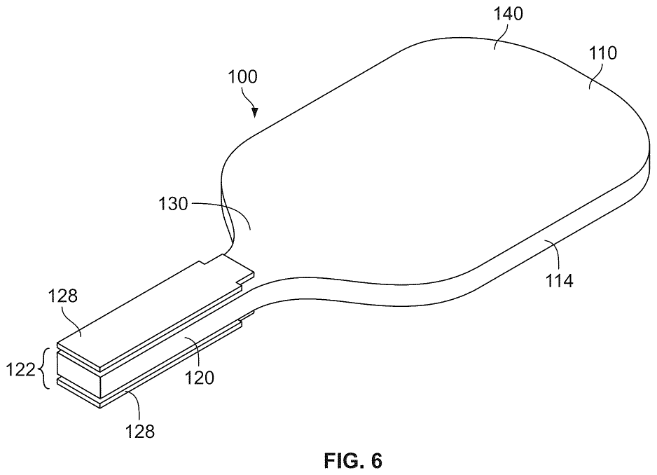

In certain optional embodiments, such as the embodiment shown in FIGS. 6-9, the grip 122 may include a pair of grip planks, each referred to herein as a grip plank 128. Each grip plank 128 may be offset from a respective one of the paddle faces 140 and/or connected to the respective paddle face 140, for example, via one or more offset blocks 190. The one or more offset blocks 190 may also be referred to herein as one or more spacers 190. In certain optional embodiments, an offset distance of each grip plank 128 relative to a respective paddle face 140 may be equal. In other optional embodiments, the offset distance of each grip plank 128 relative to a respective paddle face 140 may be unequal. The offset distance of each grip plank 128 may be adjusted through the selection of certain offset blocks 190 having differing heights. In certain optional embodiments, grip tape may be wrapped around the grip portion 120 such that the grip tape surrounds the pair of grip planks 128. While two (2) offset blocks 190 are shown in the exemplary embodiment of the grip 122 shown in FIGS. 6-9, it is within the scope of the present disclosure for the grip 122 to include a single offset block 190 and/or more than two (2) offset blocks 190.

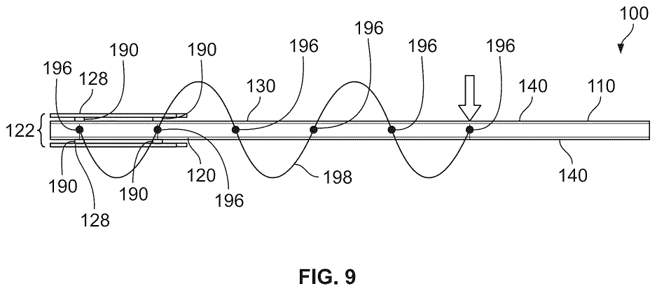

The one or more offset blocks 190 may be positioned at, over, and/or proximal to an antinode location 196 of the grip portion 120. Thus, the one or more offset blocks 190 may be connected to the grip portion 120 only through the one or more offset blocks 190. As shown in FIG. 9, a modal analysis may be performed on the pickleball paddle 100 to identify a resonant frequency and/or an associated modal shape 198. The modal shape 198 may be an exemplary frequency based on an impact, as indicated by the arrow in FIG. 9. As part of this modal analysis, the antinode locations 196 may be identified. The antinode locations 196 may be the locations about which the resonant frequency oscillates. Thus, the grip planks 128 connection to the grip portion 120 via the one or more offset blocks 190 positioned at the antinode locations 196 may be configured to minimize the transfer of energy from the grip portion 120, neck portion 130, and/or impact portion 110 into the grip planks 128. Thus, the grip planks 128 and the associated one or more offset blocks 190 may be configured to reduce the vibration transferred to a user of the pickleball paddle 100 when the pickleball paddle 100 contacts a pickleball ball.

It is within the scope of the present disclosure for the grip portion 120 to include any combination of the plurality of dampening layers adjacent to the grip portion 120 of each paddle face 140, the pair of grip planks 128, and the one or more offset blocks 190.

In certain optional embodiments, the pickleball paddle 100 may be configured to reduce the vibration felt by a user of the pickleball paddle 100 when the pickleball paddle 100 contacts a pickleball ball or any other object. In certain optional embodiments, the pickleball paddle 100 may be further configured to substantially equalize the vibration felt by a user of the pickleball paddle 100 irrespective of where on the paddle face 140 the pickleball ball contacts. Prior-art pickleball paddles 10 suffer from excess vibration felt by a user when the pickleball ball contacts the pickleball paddle 10, and further from varied amounts of vibration based on where on the paddle face 140 the pickleball ball contacts. Oftentimes, the vibration felt by the user will be increased when the pickleball ball contacts portions of the paddle face 140 outside the primary impact area 112. Vibration and/or vibrational feedback is undesirable in pickleball paddles 10, and is associated with poor performance of the pickleball paddle 10.

It is within the scope of the present disclosure for the several embodiments of the grip 122 discussed herein, or variations thereof, to be included in other sports equipment, including, but not limited to, baseball bats, softball bats, tennis rackets, badminton rackets, squash rackets, padel rackets, racquetball rackets, lacrosse sticks, field hockey sticks, ice hockey sticks, cricket bat, or the like. In one exemplary embodiment, a baseball bat may include a grip portion configured to be grasped by a user. The baseball bat may include a plurality of offset blocks 190 that circumscribe the grip portion of the baseball bat. Thus, each of the plurality of offset blocks 190 may each form a ring about the grip portion. The grip plank 128 may be connected to the plurality of offset blocks 190 and thus offset from the grip portion. The grip plank 128 may substantially cylindrical in shape and/or mimic the shape of the grip portion of the baseball bat. The grip planks 128 may be connected to the grip portion of the baseball bat via the one or more offset blocks 190 positioned at the antinode locations 196. The antinode locations 196 may be the locations about which the resonant frequency oscillates on the baseball bat. The location of the offset blocks 190 may be configured to minimize the transfer of energy from the grip portion of the baseball bat into the grip plank 128. Thus, the grip plank 128 and the associated offset blocks 190 may be configured to reduce the vibration transferred to a user of the baseball bat when the baseball bat contacts a baseball.

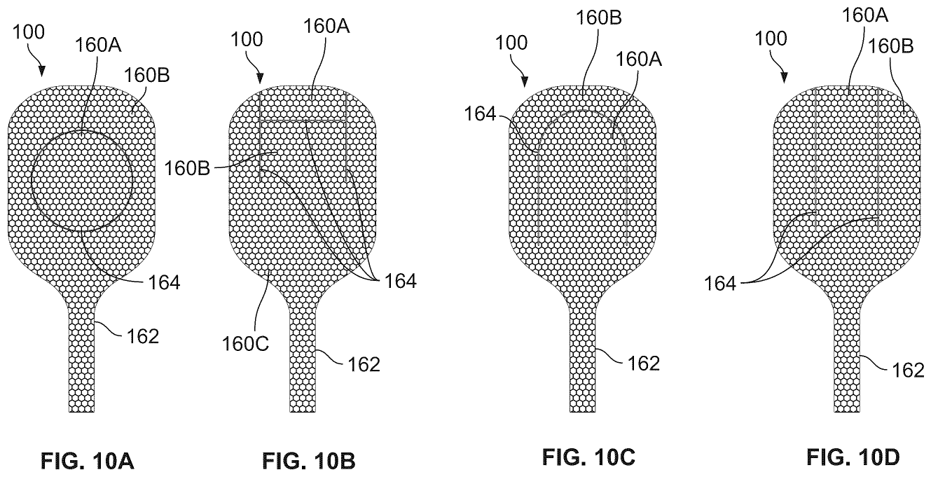

Referring now to FIGS. 10A-12, in certain optional embodiments, the pickleball paddle 100 may include a core 160. The core may be positioned between the pair of paddle faces 140. In certain optional embodiments, the core 160 may extend throughout the impact portion 110, the grip portion 120, and/or the neck portion 130. In certain optional embodiments, the core may be made of foam or a like material. In certain optional embodiments, the core 160 may comprise a honeycomb structure 162. In certain optional embodiments, the honeycomb structure 162 of the core 160 may be non-homogeneous in nature, such that the honeycomb structure 162 includes one or more discontinuities 164. In certain optional embodiments, the discontinuities may be linear slices removed from or added to the honeycomb structure 162, non-linear portions removed from or added to the honeycomb structure 162, linear or non-linear reinforcement structures coupled to or associated with the honeycomb structure 162, and/or a layered or arranged combination of two or more honeycomb structures 162 such that they form a single core 160, to name a few examples. In certain optional embodiments, the one or more discontinuities 164 of the core 160 may divide the core 160 into two or more sections such that certain sections may have differing characteristics from other sections. While certain features may be described herein in connection with a core 160 having a honeycomb structure 162, it is within the scope of the present disclosure for these features to equally apply to other cores 160, such as a core made of foam or a like material.

FIGS. 10A-10D depict several exemplary embodiments of a core 160 including the honeycomb structure 162 of an exemplary pickleball paddle 100 in accordance with the present disclosure. The exemplary embodiments of the core 160 of the pickleball paddle 100 of FIGS. 10A-10D include a honeycomb structure 162 that is discontinuous, or otherwise includes at least one discontinuity 164. Each of the discontinuities 164 shown in FIGS. 10A-10D are portions where the honeycomb structure has a gap defined therein, for example, where a material removing cut has been made to the core 160 to define the discontinuity 164. Each optional embodiment of the core 160 will be discussed in further detail below.

FIG. 10A depicts a core 160 having a honeycomb structure 162 and a discontinuity 164 in the shape of a circle. In this optional embodiment, the core 160 may include a first section 160A positioned inside the circular discontinuity 164 and a second section 160B positioned outside the circular discontinuity 164. In certain optional embodiments, the first section 160A and the second section 160B may be comprised of the same material. In other optional embodiments, the first section 160A and the second section 160B may be comprised of different materials.

FIG. 10B depicts a core 160 having a honeycomb structure 162 and a discontinuity 164 having three linear portions that are connected such that the linear portions generally form an “H” shape. The three linear portions may include a pair of vertical sections and a horizontal section. In this optional embodiment, the core 160 may include a first section 160A positioned above the horizontal section and inside the pair of vertical sections of the H-shaped discontinuity 164, a second section 160B positioned below the horizontal section and inside the vertical sections of the H-shaped discontinuity 164, and a third section 160C positioned outside the discontinuity 164. In certain optional embodiments, the first section 160A, the second section 160B, and/or the third section 160C may be comprised of the same material. In other optional embodiments, the first section 160A, the second section 160B, and/or the third section 160C may be comprised of different materials.

FIG. 10C depicts a core 160 having a honeycomb structure 162 and a discontinuity 164 in a “U” shape. In this optional embodiment, the core 160 may include a first section 160A positioned inside the U-shaped discontinuity 164 and a second section 160B positioned outside the U-shaped discontinuity. In certain optional embodiments, the first section 160A and the second section 160B may be comprised of the same material. In other optional embodiments, the first section 160A and the second section 160B may be comprised of different materials.

FIG. 10D depicts a core 160 having a honeycomb structure 162 and a discontinuity 164 that comprises two offset linear portions. In this optional embodiment, the core 160 may include a first section 160A positioned inside the linear portions of the discontinuity 164 and a second section 160B positioned outside the linear portions of the discontinuity 164. In certain optional embodiments, the first section 160A and the second section 160B may be comprised of the same material. In other optional embodiments, the first section 160A and the second section 160B may be comprised of different materials.

While FIGS. 10A-10D depict several exemplary embodiments of a core 160 with varying discontinuity 164 shapes, one of skill in the art will recognize that other discontinuity 164 shapes are within the scope of the present disclosure. Further, each section of the core 160 may be comprised of the same material or of different materials.

In certain optional embodiments, different materials may be used in different portions of the core 160, and may be strategically placed adjacent to and/or in relation to the impact portion 110. For example, in the exemplary core 160 shown in FIG. 10A, a first material may be located inside of the circular discontinuity 164 in the first section 160A, and a second material may be located outside of the circular discontinuity 164 in the second section 160B. The first material and the second material may have different material properties, such as different strength and/or stiffness properties.

In certain optional embodiments, different materials may be used in different portions of the core 160 such that the impact portion 110, grip portion 120, and/or neck portion 130 are comprised of different materials. In certain optional embodiments, the same materials may be used in different portions of the core 160 such that the impact portion 110, grip portion 120, and/or neck portion 130 are comprised of the same material.

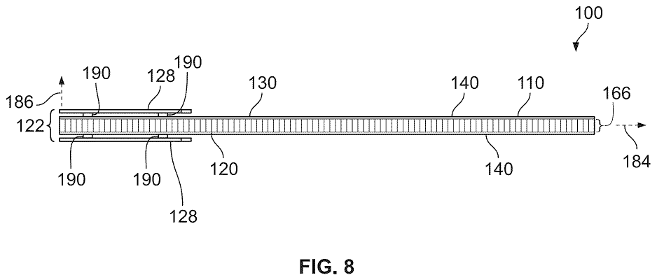

The pickleball paddle may include an x-axis 182, y-axis 184, and/or z-axis, as shown in FIGS. 3 and 8. The y-axis 184 of the pickleball paddle 100 as defined herein may extend along a centerline of the grip portion 120 through the neck portion 130 and the impact portion 110. The x-axis 182 of the pickleball paddle 100 as defined herein may be positioned perpendicular to the y-axis 184 and adjacent to a terminal end of the grip portion 120. The z-axis 186 of the pickleball paddle 100 as defined herein may be positioned perpendicular to the x-axis 182 and y-axis 184 such that it extends up from the terminal end of the grip portion 120.

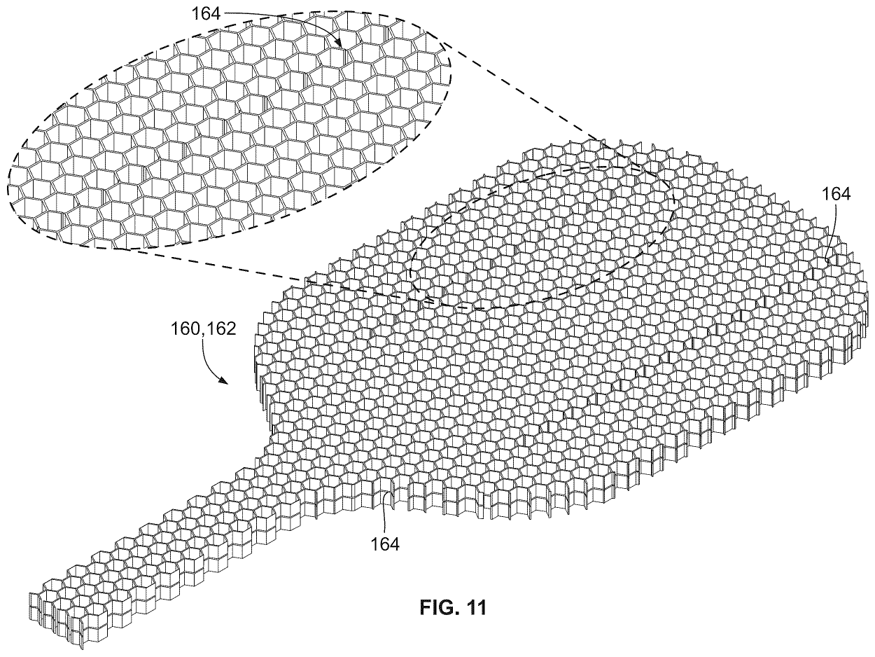

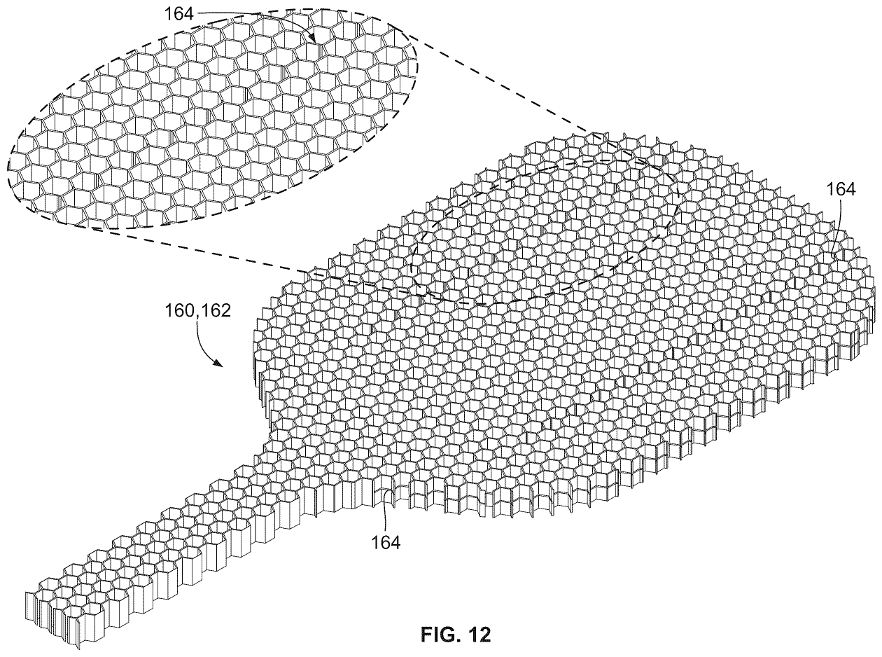

In certain exemplary embodiments, the core 160 may include a core thickness 166, as shown in FIG. 8. The core thickness 166 may be defined as a distance between the pair of paddle faces 140. Thus, the core thickness may be the distance between paddle faces 140 in the z-direction. In certain exemplary embodiments, as previously discussed, the discontinuity 164 may be defined parallel to the core thickness 166. Thus, the discontinuity 164 may be defined in the core 160 in the z-direction, as shown in FIGS. 10A-10D for example. In certain exemplary embodiments, the discontinuity 164 may be defined perpendicular to the core thickness 166. Thus, the discontinuity 164 may be defined in the core 160 in the x-direction and/or y-direction, as shown in FIGS. 11 and 12 for example.

A discontinuity 164 defined in the core 160 in the x-direction and/or y-direction may extend across the entirety of the core 160, or may only extend through a portion of the core 160. FIG. 11 shows an exemplary embodiment of the core 160 of the pickleball paddle 100 of in accordance with the present disclosure. The core 160 includes a discontinuity 164 defined in the core 160 in the x-direction and/or y-direction extending through an entirety of the core 160. The discontinuity 164 is defined perpendicular to the core thickness 166. FIG. 12 shows an exemplary embodiment of the core 160 of the pickleball paddle 100 in accordance with the present disclosure. The core 160 includes a discontinuity 164 defined in the core 160 in the x-direction and/or y-direction extending through only a portion of the core, and specifically only through the impact portion 110 of the core 160. The discontinuity 164 is defined perpendicular to the core thickness 166. As shown, the discontinuity 164 defined in the core 160 in the x-direction and/or y-direction may extend across the entirety of the core 160, or may only extend through a portion of the core 160.

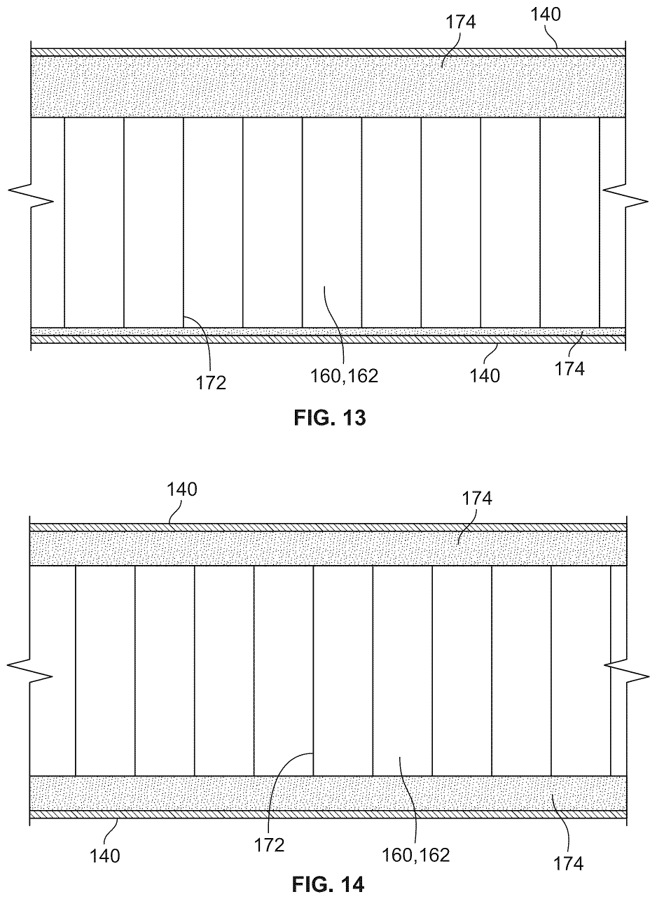

Referring now to FIGS. 13 and 14, in certain optional embodiments, the core 160 may include multiple layers of material, and the layering of the material may constitute a discontinuity 164. In certain optional embodiments, a first layer of a first material may be positioned nearest a first paddle face of the pair of paddle faces 140, a second layer of the first material may be positioned nearest a second paddle face of the pair of paddle faces, and a second material may be positioned between the first and second layers of first material. The first material and the second material may have different material properties, such as different strength and/or stiffness properties. Thus, an exemplary embodiment of the core 160 including layering of the first material and the second material may be described herein as being a discontinuous core 160.

In certain optional embodiments, the core 160 of the pickleball paddle 100 may include two or more layers that have a similar size, shape, thickness, and/or material property. For example, the core 160 may include a first layer and a second layer and each layer may have a honeycomb structure 162 with a circular discontinuity 164 similar to the embodiment of FIG. 10A. In other optional embodiments, the core 160 of the pickleball paddle 100 may include two or more layers that have a different size, shape, thickness, and/or material property. For example, the core 160 may include a first layer having a honeycomb structure 162 with a circular discontinuity 164 similar to the embodiment of FIG. 10A, and a second layer having a honeycomb structure 162 with an H-shaped discontinuity 164 similar to the embodiment of FIG. 10B.

Collision efficiency, as used herein, may refer to the way in which the prior-art pickleball paddle 10 and/or the pickleball paddle 100 disclosed herein reacts when a pickleball ball, or any other object, makes contact therewith. One way in which the collision efficiency of the pickleball paddle 100 can be quantified may be by measuring the pickleball paddle's 100 face deflection. Face deflection, as used herein, may refer to a distance the paddle face 140 of the pickleball paddle 100 moves and/or deflects when pressure is applied thereto, such as when an object contacts the paddle face 140.

Prior-art pickleball paddles 10 suffer from low face deflection which results in poor control and overall performance when contacting a pickleball ball. Further, prior-art pickleball paddles 10 suffer from inconsistent face deflection across the paddle face 140. For example, prior-art pickleball paddles 10 often have a first face deflection value around the periphery of each pickleball face 140, and a second face deflection value in the primary impact area 112, with the first face deflection value is different than the second face deflection value. Typically, each of the first and second face deflection values, while different, are still relatively high, with the first face deflection value being magnitudes lower than the second face deflection value. Thus, users of prior-art pickleball paddles 10 may experience inconsistent feedback from the pickleball paddle 10 when contacting a pickleball ball, which may be exacerbated by contacting the pickleball ball with certain areas of the pickleball face 140.

In certain optional embodiments, the pickleball paddle 100 of the present disclosure may have a higher face deflection than prior-art pickleball paddles 10. The higher face deflection may be associated with better control and/or performance when the pickleball paddle 100 strikes a pickleball ball, or any other object for that matter. Further, the pickleball paddle 100 of the present disclosure may experience more consistent face deflection across the paddle face 140. Thus, there may be minimal, if any, difference between a face deflection value around the periphery of each pickleball face 140 and a face deflection value in the primary impact area 112. In certain optional embodiments, a face deflection value around the periphery of each pickleball face 140 and a face deflection value in the primary impact area 112 may have a percentage change of less than 50 percent, and in some optional embodiments, less than 25 percent.

As discussed, in certain optional embodiments, the pickleball paddle 100 of the present disclosure may include the core 160 having one or more discontinuities 164. One exemplary advantage of the pickleball paddle 100 including the core 160 having one or more discontinuities 164 may be that the pair of paddle faces 140 have relatively high face deflection values and/or consistent deflection values across each paddle face 140.

One exemplary advantage of the pickleball paddle 100 disclosed herein may be that it improves collision efficiency by reducing distortion of the pickleball paddle 100 resulting from contact with a pickleball ball. There may be certain advantages, such as improved control/performance when striking a pickleball ball, associated with the pickleball paddle 100 of the present disclosure having a relatively high face deflection. Prior-art pickleball paddles 10 often have low face deflection and thus suffer from a lack of control/performance when striking a pickleball ball.

Referring now to FIGS. 13 and 14, FIG. 13 depicts a cross-sectional view of an exemplary embodiment of a pickleball paddle 100 including an asymmetrical design and FIG. 14 depicts a cross-sectional view of an exemplary embodiment of a pickleball paddle 100 including a symmetrical design. In certain optional embodiments, the core 160 of the pickleball paddle 100 may include one or more layers. A first layer 172 of the one or more layers may include a material that reduces and/or altogether stops deflection. In certain optional embodiments, the first layer 172 may include the honeycomb structure 162 and/or a carbon fiber composite to name a few examples. In certain optional embodiments, the first layer 172 may comprise a material whose stiffness is configured to be controllable. A second layer 174 of the one or more layers may include a material that generally allows for deflection. In certain optional embodiments, the second layer 174 may be disposed between the first layer 172 and a corresponding paddle face 140. Thus, an exemplary core 160 may include a second layer 174 on either side of the first layer 172 such that there the second layer 172 is positioned between the first layer 172 and each of the pair of paddle faces 140. In certain exemplary embodiments, the second layer 174 may comprise a substance with negligible and/or low stiffness characteristics relative to the first layer 172, such as gas or foam to name a few examples. In certain optional embodiments, the core 160 may be symmetrical as shown in FIG. 14, or may be asymmetrical as shown in FIG. 13. In the symmetrical embodiment shown in FIG. 14, the first layer 172 may be centered with respect to the pickleball paddle 100 core thickness 166, or centered relative to the paddle faces 140. In the asymmetrical embodiment shown in FIG. 13, the first layer 172 may be off-center with respect to the pickleball paddle 100 core thickness 166, or off-center relative to the paddle faces 140.

In certain exemplary embodiments, the pickleball paddle 100 may be configured such that each paddle face 140 deflects a distance, such as a distance equal to a thickness of the second layer 174, and is prevented from further deflection by the first layer 172. In certain optional embodiments, the first layer 172 and/or second area 174 may extend throughout the impact portion 110 or may be positioned only in certain areas of the impact portion 110.

Certain rules and regulations implemented by governing bodies of pickleball, such as USA Pickleball's Equipment Standards Manual, effectively establish a ceiling and/or limit for performance of pickleball paddles. One advantage of the present disclosure, and specifically the core 160 of the pickleball paddle 100 of the present disclosure, may be that the pickleball paddle 100 may be fine-tuned to comply with such rules and regulations. One such rule/regulation may be that the paddle face of the pickleball paddle may only deflect a given amount. Put another way, the rule/regulation may state that the face deflection value of the paddle face of the pickleball paddle may not exceed the given amount. Thus, one advantage of the present disclosure may be that the deflection of the paddle face 140 may be limited such that maximum deflection is achieved for enhanced performance/control, but the pickleball paddle 100 still complies with the rules/regulations.

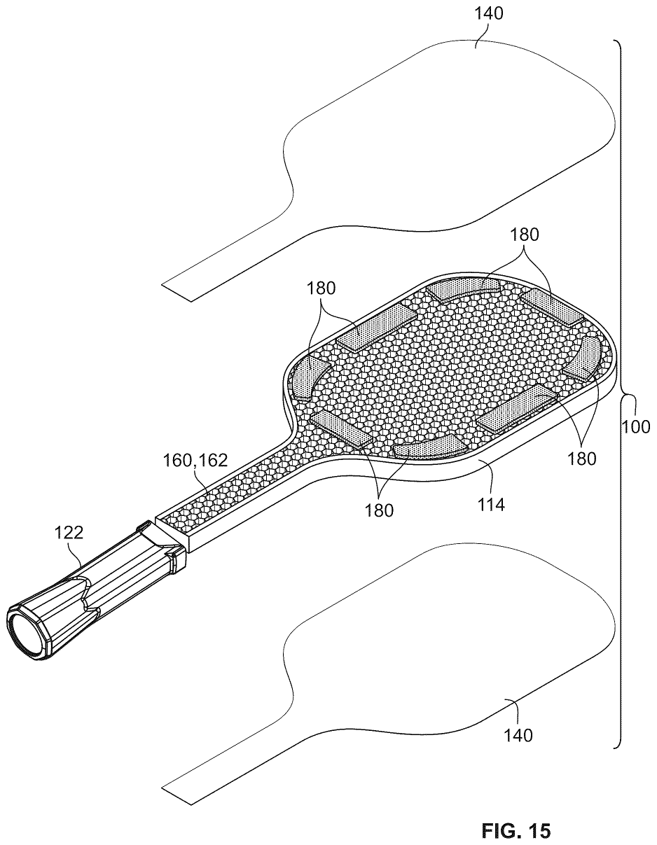

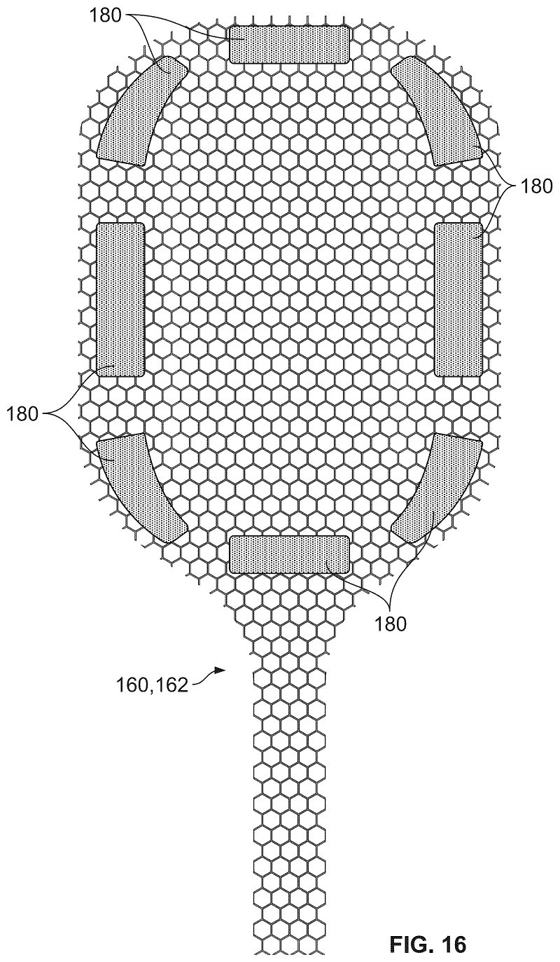

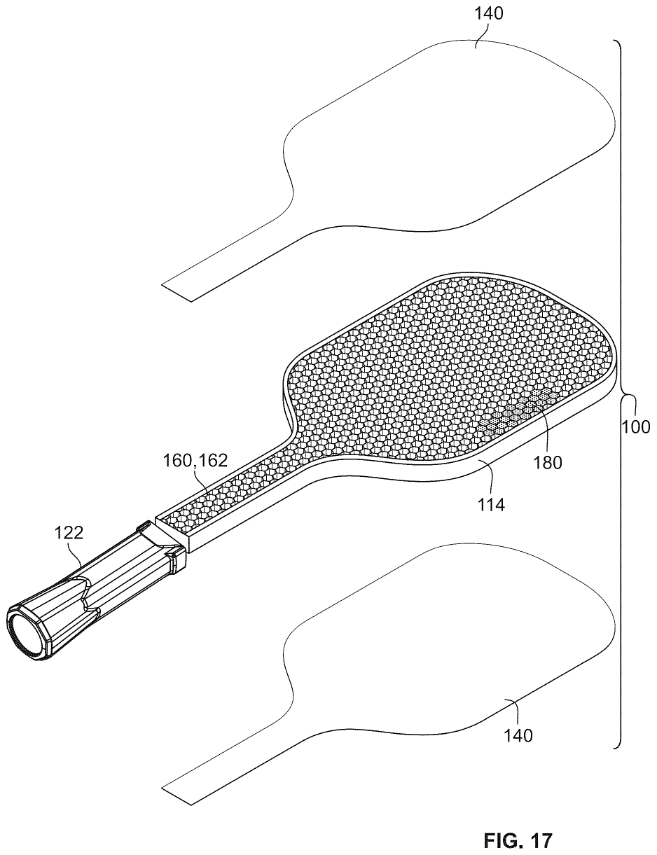

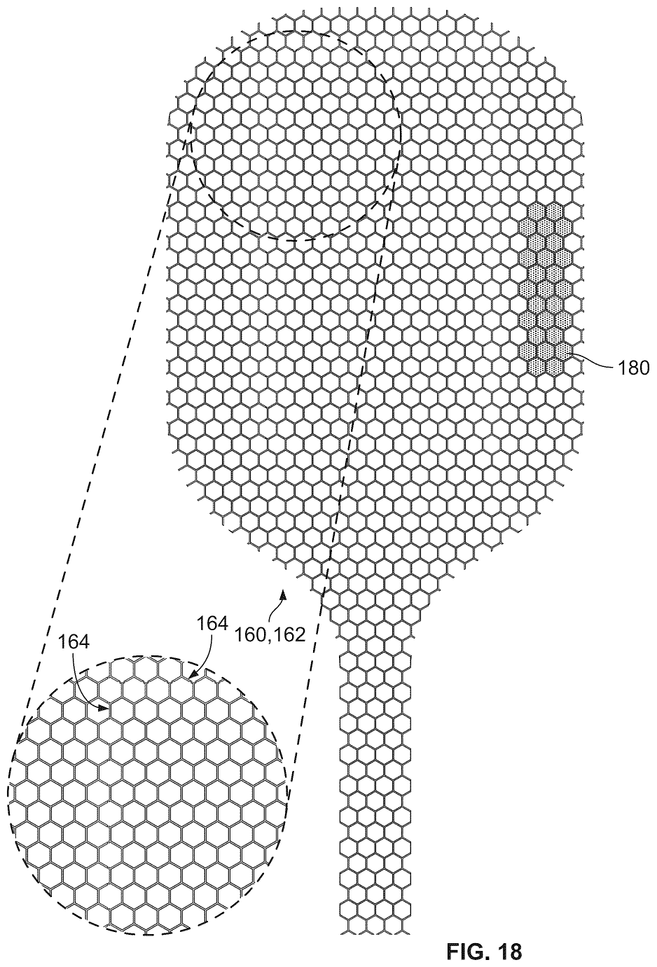

Referring now to FIGS. 15-18, in certain optional embodiments, the pickleball paddle 100 may include one or more weighted portions 180. The one or more weighted portions 180, and specifically the positioning of the one or more weighted portions 180, may be configured to aid in controlling an effective inertia of the pickleball paddle 100. FIGS. 15 and 16 show an exemplary embodiment of the pickleball paddle 100 wherein the one or more weighted portions 180 are positioned across the impact portion 110 such that the one or more weighted portions 180 partially surround the primary impact area 112. As shown in FIGS. 17-18, in certain optional embodiments wherein the core 160 includes a honeycomb structure 162, material may be added within the cells of the honeycomb structure 162 to form the one or more weighted portions 180. In certain optional embodiments, the material added within the cells of the honeycomb structure 162 may be a resin or resin-like material that may be poured into the cells and solidified during a curing process. One exemplary advantage of adding material within the cells of the honeycomb structure 162 may be that a desired amount of weight may be added to the pickleball paddle 100 and the location of the weight may be controlled. While a single weighted portion 180 is shown in FIGS. 17-18, it is within the scope of the present disclosure for two or more weighted portions 180 to be used.

In certain optional embodiments, the one or more weighted portions 180 may be coupled to, or form a portion of, the pair of paddle faces 140. More specifically, the one or more weighted portions 180 may be positioned on an interior side of each paddle face 140 such that an exterior side of each paddle face 140 remains substantially flat. For example, in certain optional embodiments of the pickleball paddle 100, each paddle face 140 may be comprised of a plurality of plies of fiberglass prepreg. One or more additional plies or pieces of plies of fiberglass prepreg, or any like material, may be added to specific areas of the interior side of each paddle face 140 to form the one or more weighted portions 180.

One exemplary advantage of the pickleball paddle 100 disclosed herein may be that the weighted portions 180 are positioned in the impact portion 110, and at or adjacent to the primary impact area 112, such that the weighted portions 180 provide additional mass to the pickleball paddle 100 without affecting, or at most minimally affecting, the rebound characteristics of the pickleball paddle 100.

In certain exemplary embodiments, inertial characteristics of a pickleball paddle 100 may be an important factor in the overall performance of the pickleball paddle 100. Inertial characteristics, as used herein, may refer to the pickleball paddle's 100 moment of inertia about the pickleball paddle's x-axis 182, y-axis 184, and or z-axis 186. As shown in FIGS. 3 and 8, the y-axis 184 of the pickleball paddle 100 as defined herein may extend along a centerline of the grip portion 120 through the neck portion 130 and the impact portion 110. The x-axis 182 of the pickleball paddle 100 as defined herein may be positioned perpendicular to the y-axis 184 and adjacent to a terminal end of the grip portion 120. The z-axis 186 of the pickleball paddle 100 as defined herein may be positioned perpendicular to the x-axis 182 and y-axis 184 such that it extends up from the terminal end of the grip portion 120. In certain exemplary embodiments, the x-axis 182 inertia may be associated with inertia about the x-axis 182 that resists the user's swing of the pickleball paddle 100, and the y-axis 184 inertia may be associated with inertia about the y-axis 184 that resists the pickleball paddle 100 from twisting relative the user's hand from off-center impacts of the pickleball ball. The inertial characteristics of the pickleball paddle 100 may be altered, controlled, or otherwise affected by at least the core 160, including the honeycomb structure, and the positioning and mass of the one or more weighted portions 180, to name a few examples.

It is within the scope of the present disclosure for several or all of the concepts and/or features discussed herein to be included in a single embodiment of the pickleball paddle 100.

Further, it is within the scope of the present disclosure for several or all of the concepts and/or features discussed herein to be included in other sports equipment, including, but not limited to, baseball bats, softball bats, tennis rackets, badminton rackets, squash rackets, padel rackets, racquetball rackets, lacrosse sticks, field hockey sticks, ice hockey sticks, cricket bat, or the like.

To facilitate the understanding of the embodiments described herein, a number of terms have been defined above (and below). The terms defined herein have meanings as commonly understood by a person of ordinary skill in the areas relevant to the present disclosure. The terminology herein is used to describe specific embodiments of the disclosure, but their usage does not delimit the disclosure, except as set forth in the claims.

The terms “attached,” “connected,” and “disposed,” (where applicable) and the like, or any variation thereof, should generally be interpreted to mean any manner of joining two objects including, but not limited to, the use of any fasteners such as screws, nuts and bolts, bolts, pin and clevis, and the like allowing for a stationary, translatable, or pivotable relationship; welding of any kind such as traditional MIG welding, TIG welding, friction welding, brazing, soldering, ultrasonic welding, torch welding, inductive welding, and the like; using any resin, glue, epoxy, and the like; being integrally formed as a single part together; any mechanical fit such as a friction fit, interference fit, slidable fit, rotatable fit, pivotable fit, and the like; any combination thereof; and the like.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” “in optional embodiments,” or “in another embodiment,” and variations thereof, as used herein, do not necessarily refer to the same embodiment, although it may. As used herein, the phrase “one or more of,” when used with a list of items, means that different combinations of one or more of the items may be used and only one of each item in the list may be needed. For example, “one or more of” item A, item B, and item C may include, for example, without limitation, item A or item A and item B. This example also may include item A, item B, and item C, or item B and item C.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. The conditional language is not generally intended to imply that features, elements, and/or states are in any way required for one or more embodiments or that one or more embodiments necessarily include logic for deciding, with or without author input or prompting, whether these features, elements and/or states are included or are to be performed in any particular embodiment. Thus, such conditional language is not generally intended to imply that features, elements, and/or states are in any way required for one or more embodiments or that one or more embodiments necessarily include logic for deciding, with or without author input or prompting, whether these features, elements and/or states are included or are to be performed in any particular embodiment.

As used herein, the term “about” is used to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of twenty-five percent (25%) up or down (higher or lower), unless stated otherwise in the disclosure or as limited by the governing body of the sport of pickleball.

The previous detailed description has been provided for the purposes of illustration and description. Thus, although there have been described particular embodiments of a new and useful PADDLE APPARATUS, it is not intended that such references be construed as limitations upon the scope of this disclosure except as set forth in the following claims. Thus, it is seen that the apparatus, methods, and/or systems of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims.

What is claimed is:

1. A paddle apparatus, comprising:
a first paddle face and a second paddle face, each of the first paddle face and the second paddle face being substantially flat; and
a core positioned between the first paddle face and the second paddle face;
wherein one or more discontinuities are defined in the core.

2. The paddle apparatus of claim 1, wherein:
each of the one or more discontinuities include a material removing cut defined in the core.

3. The paddle apparatus of claim 1, wherein:
the core is divided into two or more sections, each of the two or more sections being separated by the one or more discontinuities.

4. The paddle apparatus of claim 3, wherein:
the two or more sections of the core include a first section comprising a first material and a second section comprising a second material, the first material and second material being different.

5. The paddle apparatus of claim 4, wherein:
a stiffness of the first material is different from a stiffness of the second material.

6. The paddle apparatus of claim 1, wherein:
the one or more discontinuities are in the shape of a circle.

7. The paddle apparatus of claim 1, wherein:
the one or more discontinuities include two or more linear lines that are substantially parallel to one another.

8. The paddle apparatus of claim 1, wherein:
the one or more discontinuities are H-shaped.

9. The paddle apparatus of claim 1, wherein:
the one or more discontinuities are U-shaped.

10. The paddle apparatus of claim 1, wherein:
the core includes a pair of contact surfaces and a thickness defined between the pair of contact surfaces; and
the one or more discontinuities are defined such that the one or more discontinuities extend through the thickness of the core from a first contact surface of the pair of contact surfaces to a second contact surface of the pair of contact surfaces.

11. The paddle apparatus of claim 1, wherein:
the core includes a pair of contact surfaces and a thickness defined between the pair of contact surfaces; and
the one or more discontinuities are defined such that the one or more discontinuities extend through the thickness of the core parallel to the pair of contact surfaces.

12. The paddle apparatus of claim 11, wherein:
the one or more discontinuities extend throughout the entirety of the thickness of the core parallel to the pair of contact surfaces.

13. The paddle apparatus of claim 11, wherein:
the one or more discontinuities extend through less than the entirety of the thickness of the core parallel to the pair of contact surfaces.

14. The paddle apparatus of claim 1, further comprising:
a deflection material positioned between the first paddle face and the core, and between the second paddle face and the core.

15. The paddle apparatus of claim 14, wherein:
a stiffness of the deflection material is less than a stiffness of the core.

16. The paddle apparatus of claim 1, further comprising:
one or more weighted portions positioned between the first paddle face and the second paddle face.

17. The paddle apparatus of claim 14, wherein:
a first weighted portion of the one or more weighted portions is positioned between the first paddle face and the core, and a second weighted portion of the one or more weighted portions is positioned between the second paddle face and the core.

18. The paddle apparatus of claim 14, wherein:
the core includes a honeycomb structure and the one or more weighted portions are disposed within apertures of the honeycomb structure of the core.

19. The paddle apparatus of claim 1, wherein:
the core includes a honeycomb structure having a plurality of apertures defined therein.
